(19) United States
(12) Patent Application Publication
(10) Pub. No.: US 2004/0201121 A1
(43) Pub. Date: Oct. 14, 2004

(54) Cellulose sponge and method of production thereof

(76) Inventors: Eduard Mulleder, Lambach (AT); Heinrich Firgo, Vocklabruck (AT); Olivier Bedue, Paris (FR)

Correspondence Address: Daniel J Warren, Sutherland Asbill & Brennan, 999 Peachtree Street NE, Atlanta, GA, 30309-3996, US

(21) Appl. No.: 10/484,607

(22) PCT Filed: Jul. 25, 2002
(86) PCT No.: PCT/AT02/00221

(30) Foreign Application Priority Data
Jul. 25, 2001 (AT) A 1161/2001

(51) Int. Cl. B29D 1/00

(52) U.S. Cl. 264/51

(57) ABSTRACT

The invention relates to a process for producing a cellulose sponge by using tertiary amine oxides, wherein a mixture of cellulose and further ingredients such as pore formers (gas, salt or blowing agents) is produced in an aqueous tertiary amine oxide, which mixture contains undissolved and/or highly swollen cellulose, and the mixture is formed and coagulated.

The suitability of tertiary amine oxides, in particular of NMMO, as swelling agents and solvents is sufficiently well known and is used for the industrial manufacture of fibres and other cellulosic moulded bodies.

A process for producing a cellulose sponge from a solution of cellulose in NMMO is described in WO 97/23552.

WO 98/28360 describes the manufacture of a cellulose sponge which is coagulated from a cellulose solution, with the cellulose exhibiting an average degree of polymerization which does not exceed 800. WO 99/27835 describes a cellulose-based sponge cloth, wherein a solution of cellulose in an aqueous amine-oxide solution is produced, which subsequently is mixed with at least one pore former as well as fibres. That mixture is spread on a conveying belt, which then is passed through a coagulating bath, the temperature of which is high enough to cause the pore former to melt and be leached out.

In all those processes, the basis of producing the product is the use of an NMMO-cellulose solution in the respective concentration. According to the state of the art, that process is referred to as the Lyocell process or the amine-oxide process.

Usually, the process consists of:

mixing the cellulose with an NMMO/water-solution containing an excess amount of water, followed by heating while, at the same time, water is evaporated until the solvent concentration is reached at which the pulp is then dissolved. In doing so, a clear solution always is produced.

Thus, the operation is always performed in the soluble range of the dissolving range defined according to Franks et al. (U.S. Pat. No. 4,196,282). According to U.S. Pat. No. 4,196,282, the upper limit of that dissolving range with regard to the water content is indicated in the ternary mixture of water-NMMO-cellulose by means of the following formula:

c_{Cell=}34,69−1,695*c_{H2O}+0,81*\sqrt{1,65+0,1*(c_{H2O}−12,76)²},

wherein c_{cell} denotes the concentration of the cellulose (% by weight) in the ternary mixture and C_{H2O} denotes the concentration of the water (% by weight) in the ternary mixture.

The upper limit for the possible cellulose concentration as indicated by that formula comprises the so-called confidence range. That means that, if the concentration of the cellulose is smaller than the value derived from the right-hand part of the formula, a solution will result with a probability of 95%.

The aim and essence of the known processes for producing cellulose sponges according to the amine-oxide process always consists in the preparation of an NMMO/cellulose solution which is within that defined dissolving range.

The existence of cellulose solutions outside that dissolving range is described in DD 226 573 as well as in EP 0 452 610, whereby high shearing rates are necessary for producing such solutions.

However, the preparation of a cellulose solution according to the amine-oxide process is tedious. Moreover, the transport and processing of such cellulose solutions is associated with a safety risk, since the solutions are given to exothermal decomposition reactions.

As opposed thereto, in the process of the invention for producing a cellulose sponge by using tertiary amine oxides, a mixture of cellulose and further ingredients such as pore formers (gas, salt or blowing agents) is produced in an aqueous tertiary amine oxide, which mixture contains undissolved and/or highly swollen cellulose, and the mixture is formed and coagulated.

By “forming”, a person skilled in the art understands the shaping of the mixture to a sponge cloth or to a block sponge according to methods known per se.

A person skilled in the art can easily determine the presence of undissolved and/or highly swollen cellulose by examining the mixture with a microscope.

Preferably, the aqueous tertiary amine-oxide is N-methyl morpholine-N-oxide and the expression

A>34,69−1,695*B+0,81*\sqrt{1,65+0,1*(B−12,76)²}

is fulfilled in the mixture, wherein

A is the content of cellulosic material in the mixture (% by weight), based on the sum of the percentages by weight of cellulosic material, water and amine oxide in the mixture, and

B is the water content in the mixture (% by weight), based on the sum of the percentages by weight of cellulosic material, water and amine oxide in the mixture.

That means that the content of cellulosic material, based on the content of the ternary mixture of cellulosic material, water and amine oxide in the mixture, preferably is outside the range defined by U.S. Pat. No. 4,196,282. The result is that—unless any particular measures according to DD 226 573 or EP 0 452 610 are taken—at least a portion of the cellulosic material is provided in its undissolved state.

Thereby, the term “cellulosic material” denotes the sum of the cellulosic materials in the mixture, namely, on the one hand, the cellulose (f.i. pulp) used for preparing the mixture, and, on the other hand, cellulosic reinforcement fibres, which optionally are employed additionally in accordance with a preferred embodiment of the invention.

As opposed to the state of the art, the process of the invention consists in the use of NMMO in a concentration which preferably is capable of dissolving a certain amount of cellulose but not the entire amount of cellulose. The water content of the NMMO used for the production may amount to from 15% by weight to 30% by weight, preferably from 17% by weight to 26% by weight, particularly preferably from 19% by weight to 24% by weight, most preferably 22% by weight.

However, the content of cellulosic material may also be within the range defined by U.S. Pat. No. 4,196,282, if mixing the components is carried out such that no dissolution occurs. That may be achieved by appropriately adjusting the mixing time, the temperature as well as the shearing rates applied.

Regarding the production of cellulosic moulded sponge bodies, it has been shown that surprisingly the preparation of a cellulose solution according to the conventional amine-oxide process may be omitted.

In doing so, the procedure preferably is such that more cellulose is provided than the amount of NMMO—water is able to dissolve.

A doughy mixture of highly swollen cellulose particles and dissolved cellulose is obtained, which, in part, is located in the soluble part according to U.S. Pat. No. 4,196,282 and, in part, outside that dissolving range.

Thermally, that mixture is by far more stable than a complete cellulose solution so that, in the process of the invention, in particular when NMMO having a large water content is used and processing is carried out at low temperatures, numerous sophisticated safety measures such as complex constructions for minimizing dead spots, the provision of bursting disks or the use of stabilizers may be dispensed with.

Depending on the respective components, a person skilled in the art can easily determine the temperature range favourable for producing and forming the mixture. Special attention must be taken that reinforcement fibres which are used optionally do not dissolve at the applied temperatures. The respective melting point of the amine oxide/water mixture, which results from the water content of the amine oxide, usually is regarded as the lower limit for the temperature. 105° C. has proven to be suitable as the upper limit. Preferably, the temperature for producing and forming the mixture ranges from 80° C. to 100° C.

Thus, the mixture obtained according to said process only has the use of NMMO as a solvent in common and, therefore, differs from an amine-oxide process in various respects:

Process according to the invention:

1) The mass contains highly swollen cellulose.

2) The mass contains undissolved cellulose.

3) The mass preferably contains cellulose outside the conventional dissolving diagram according to U.S. Pat. No. 4,196,282.

4) As opposed to the amine-oxide process, the preparation of the mass is not aimed at obtaining a clear or almost clear solution.

According to a preferred embodiment of the process of the invention, a premix consisting of cellulose, aqueous amine oxide and optionally a stabilizer is prepared.

Preferably, the aqueous tertiary amine oxide is N-methyl morpholine-N-oxide and the expression

A1>34,69−1,695*B1+0,81*\sqrt{1,65+0,1*(B1−12,76)²}

is fulfilled in the premix, wherein

A1 is the cellulose content in the premix (% by weight), based on the sum of the percentages by weight of cellulose, water and amine oxide in the premix, and

B 1 is the water content in the premix (% by weight), based on the sum of the percentages by weight of cellulose, water and amine oxide in the premix.

That again means that, in the premix, the content of cellulose (f.i. pulp) used in the ternary mixture of cellulose, water and amine oxide in the mixture preferably is outside the range defined by U.S. Pat. No. 4,196,282. The result is that, also in the premix, at least a portion of the cellulose is provided in its undissolved state.

In order to produce the premix, the cellulose/NMMO mixture preferably is only heated but no water is evaporated.

A further preferred embodiment of the present invention is characterized in that the concentration of dissolved cellulose in the premix is smaller than 7% by weight of cellulose, preferably ranges from 2 to 6% by weight of cellulose, particularly preferably from 3 to 4% by weight of cellulose, based on the sum of the percentages by weight of cellulose, water and amine oxide.

A range of concentration which is smaller than 7% of dissolved cellulose, based on the entire premix, has turned out to be advantageous with regard to the quality of the product. In experiments, the water retention capacity of sponges produced from premixes having low concentrations of cellulose displayed a higher value than that of premixes of higher concentrations.

Due to the cellulose concentration, the NMMO concentration may be kept low in comparison with the current amine-oxide process, in particular if the amount of cellulose provided for producing the premix advantageously is smaller than 7%.

This fact introduces an essential aspect regarding safety into that novel process.

According to a further preferred embodiment, the mixture contains undissolved reinforcement fibres. Preferably, those reinforcement fibres may be added to the premix.

The reinforcement fibres may be synthetic fibres and/or cellulose fibres but also inorganic fibres such as glass fibres. Preferably, the reinforcement fibres should be insoluble or at least poorly soluble in the environment of the mixture or the premix, respectively.

Preferably, cotton fibres, flax fibres and/or cross-linked manmade cellulose fibres such as cross-linked Lyocell fibres are used as cellulosic reinforcement fibres.

Preferably, polyester, polyamide, polypropylene, polyethylene and/or polyacrylic fibres are used as synthetic reinforcement fibres.

If the reinforcement fibres are cellulose fibres, the total content of cellulosic material in the mixture preferably amounts to less than 12% by weight, based on the sum of the contents of cellulosic material, amine oxide and water in the mixture.

A person skilled in the art will be able to determine the type and amount of the reinforcement fibres depending on the desired product properties but also depending on the properties of the starting material.

If, for instance, a pulp having large amounts of long fibres is used as a starting material for the mixture or premix, respectively, the undissolved amounts of that pulp will already trigger a reinforcing effect so that only small amounts of additional reinforcement fibres or even no reinforcement fibres at all will have to be added.

In the process according to the invention, the further ingredients such as pore formers (gas, salt or blowing agents) preferably are added to the premix. That is, at first the premix of cellulose and aqueous amine oxide is prepared, and then the further ingredients are added to that premix.

However, it is also possible to mix all components (i.e. aqueous amine oxide, cellulose and further ingredients) at the outset, that is, without a premix being prepared separately.

Preferably, the mixture contains a salt as the pore former.

The use of salts as the pore formers for sponges is known from the state of the art. For instance, sodium chloride, sodium sulfate, potassium chloride and potassium sulfate are used.

In the mixture, the ratio between the weight percentage of salt and the sum of the weight percentages of cellulosic material, amine oxide and water may amount to from 2:1 to 8:1, preferably from 3:1 to 7:1, particularly preferably from 4:1 to 7:1, in the process according to the invention.

It has turned out to be favourable if the salt has different grain-size fractions.

Preferably, the salt has at least partially a grain size of from 0.1 to 2 mm. Furthermore, the salt preferably has at least partially a grain size of more than 3 mm.

In that connection, the following trends have been observed:

If salt having grain sizes of from 0.1 to 2 mm is used, the absorption capacity of the obtained sponges will be increased. If salt having grain sizes of more than 3 mm is used, generally the density of the obtained sponges will be decreased. If reinforcement fibres are used, the strength of the obtained sponges will be increased, in contrast to that, however, the absorption capacity will be decreased and the density will be increased.

If low molecular weight pulp is used, generally a greater absorption capacity of the obtained sponges is observed.

The strength of block sponges produced according to the invention will be increased if, after filling into a mould, the mixture is pressed with pressures of typically from 20 to 40 bar.

Furthermore, the strength of the obtained sponges will be increased if the mixture is cooled prior to coagulation or washing out, respectively. That effect will be particularly pronounced if the mixture is cooled down to room temperature or even to temperatures of less than 0° C.

According to the respective profile of requirements of the desired sponge, a person skilled in the art can choose from the above trends the suitable parameters and components for producing the sponge.

Furthermore, the properties of the sponges of the invention can be influenced by the fact that the mixture contains ingredients which impart functional properties to the sponge. For instance, agents having biocidal, fungicidal and/or antibacterial functions (f.i. for using the sponge as a filtering agent); colorants, agents which impart ionic properties such as, f.i., cationization agents; agents which improve the absorption properties of the sponge such as, f.i., highly absorbent particles; abrasive particles or fibres etc. belong thereto.

Also at least a portion of the reinforcement fibres which are used optionally can themselves be chemically functionalized, i.e. they can carry functional groups having, f.i., biocidal, fungicidal, antibacterial, absorptive functions etc.

Preferably, processing is carried out in a single apparatus, which means that the pore formers such as gas-propellent organic or inorganic substances, respectively, salts or gases as well as reinforcement materials—cellulosic as well as non cellulosic materials—are mixed in one and the same apparatus and simultaneously part of the cellulosic materials is solubilized by the present amine oxide.

The apparatus used to that end preferably is a combination of a mixer and a kneader and optionally an extruder.

Preferably, that process may be carried out such that—as opposed to the conventional amine-oxide process—no water is evaporated.

A typical process for producing cellulose sponges in accordance with the present invention therefore comprises the following steps:

1) Preparation of a mixture of cellulose fibres of different or identical origin and type in sheet or fluff form as well as optionally of reinforcement fibres by means of NMMO/water in a particular concentration.

2) After heating, pore formers are added, which addition, optionally, may also take place already at the beginning of producing the mass.

3) Forming by extrusion or mould-filling.

4) Coagulation in water.

Preferably, the steps 1 and 2 are carried out in an aggregate without water being evaporated—the use of mixer-extruder apparatuses such as offered by Messrs. List or Messrs. Buss, respectively, for example “List ORP, List CRP-Apparate”, is particularly advantageous, which apparatuses are particularly well suited for highly viscous materials forming crusts (salt as a porophore).

In addition, if those types of apparatuses are used, it is feasible to work a particularly large amount of gas into the mass, which is particularly beneficial to the quality of the finished sponges as a result of the formation of pores. The working in of gases may be performed in this manner by working at a normal air pressure or overpressure, respectively, in one of the mixing chambers—instead of the common mode of operation below atmospheric pressure.

If extruders are used, furthermore also liquid and/or supercritical carbon dioxide may be admixed as a propellent gas.

Surprisingly, that combination of steps permits the use of a process for producing sponges wherein all components are combined in one apparatus, a partial solution is prepared and hence undissolved amounts are provided for the reinforcement of formed pieces. At the same time, gas may optionally be introduced into the mass. Optionally, operation without any evaporation unit additionally is possible, since the respective concentration of NMMO/water may be provided already during mixing.

Producing such masses in a single aggregate by using amine oxide is novel. Producing such mixtures by means of pore formers while, at the same time, dissolving and solubilizing cellulose in a single aggregate has not yet been described, either.

It is surprising that it is feasible to effect in a single aggregate several physical procedures: the dissolution, the mixing of solid and viscous liquid phases as well as the suspension of gas in a solid-viscous liquid mixture.

It is particularly surprising that, in this process for producing sponges, no cellulose solution has to be prepared according to the conventional amine-oxide process conforming with the state of the art.

The present invention also relates to a cellulose sponge which is obtainable according to the process of the invention.

Preferably, the cellulose sponge is provided in the shape of a block sponge. A person skilled in the art is familiar with the procedure of producing block sponges from cellulose solutions or according to the viscose process, respectively.

However, according to the process of the invention, the mixture may also be processed to a sponge cloth in a manner known per se.

Preferably, block sponges according to the invention are characterized by a density of from 20 to 60 kg/m³, preferably from 25 to 45 kg/m³, an absorption capacity of from the 10 to the 40-fold, preferably from the 15 to the 30-fold, of the dead weight and a strength of from 0.5 to 5 daN/cm² (dekaNewton).

Thereby, the properties of sponges according to the invention, which have not yet been dried after coagulation or washing out, respectively (so-called “never dried” sponges), are to be distinguished from the properties of sponges which have been dried already at least once.

### EXAMPLES

### Comparative example 1

### Production of Sponges According to the Conventional Amine-oxide Process

Starting out from an aqueous amine-oxide solution having a water content of 50%, a cellulose solution of the following composition was produced by heating, evaporation of water and applying a shearing force in a manner known per se:

| | |
|---|---|
| NMMO | 75.3% by weight |
| cellulose (type Solucell, viscosity SCAN 400, | 13.4% by weight |
| manufacturer Bacell S.A.) | |
| water | 11.3% by weight |

Thereby, the cellulose is provided in a completely dissolved state.

NaCl having a grain size of from 0.1 to 1 mm was added to that solution in a weight ratio of 6.1:1. The obtained mixture was placed into a mould for the production of block sponges and was coagulated or washed out, respectively, with water for 11 hours at 50° C. and subsequently for 2 days at 25° C.

In the state of never having been dried, the obtained sponge possessed the following properties:

| | |
|---|---|
| density | 51.5 g/l |
| strength | 0.44 daN/cm² |
| water retention capacity (WRC) | 19.5 times the dead weight |

Those properties are measured as follows:

Density:

In order to determine the density of a sponge, the dimension (volume) of the wet sponge and the mass of the dry sponge are evaluated. Thereby, the density (volume weight) is derived from the quotient of the mass of the dry sponge and the volume of the wet sponge.

Water Retention Capacity (WRC):

The never dried sponge or, in the case of sponges which have been dried already once, a newly dampened sponge is taken from the water and is wiped and weighed. After drying at 60° C. in the drying chamber, the sponge is weighed again. The water content in the sponge is derived from the difference between the mass in the wet state and the mass in the dry state. This water content is divided by the mass in the dry state. The resulting quotient (i.e. the x-fold of the dead weight in the dry state) is the WRC.

Strength:

In order to evaluate the strength, a test specimen is clamped in and the force is evaluated until the test specimen tears apart. Prior to that, the cross section of the test specimen is measured. The measured maximum force prior to tearing apart is divided by the cross-sectional area and thus results in the strength which is expressed in daN (dekaNewton)/cm².

### Comparative example 2

A cellulose solution was prepared as in comparative example 1 but with the cellulose solution having the following composition:

| | |
|---|---|
| NMMO | 79.5% by weight |
| cellulose (Extranier F, manufacturer | 6.7% by weight |
| Messrs. Rayonier) | |
| water | 13.8% by weight |

NaCl having a grain size of from 0.1 to 1 mm was added to that solution in a weight ratio of 6.1: 1. The obtained mixture was placed into a mould for the production of block sponges and was coagulated or washed out, respectively, with water for 2 days at 50° C.

In the state of never having been dried, the obtained sponge possessed the following properties:

| | |
|---|---|
| density | 39.8 g/l |
| strength | 0.47 daN/cm² |
| water retention capacity (WRC) | 29.7 times the dead weight |

### Example 1 (according to the invention)

50% NMMO and pulp (Extranier F) were provided. Subsequently, such an amount of water was evaporated that a premix resulted which had the following composition:

| | |
|---|---|
| NMMO | 76.3% by weight |
| cellulose | 6.6% by weight |
| water | 17.1% by weight |

In that premix, the cellulose content indeed is within the dissolving range defined by U.S. Pat. No. 4,196,282. However, a portion of the cellulose was provided in its undissolved state since the premix had been stirred too briefly for causing complete dissolution.

Salt was added to that premix in a ratio of 5.3:1. The obtained mixture was cooled down to room temperature, was placed into a mould for the production of block sponges and was coagulated or washed out, respectively, with water for 48 hours at 50° C.

In the state of never having been dried, the obtained sponge possessed the following properties:

| | |
|---|---|
| density | 36.8 g/l |
| strength | 0.36 daN/cm² |
| water retention capacity (WRC) | 27.4 times the dead weight |

### Example 2 (according to the invention)

The same procedure as in Example 1 was followed but with the premix having the following composition:

| | |
|---|---|
| NMMO | 73.3% by weight |
| cellulose | 6.4% by weight |
| water | 20.4% by weight |

In that premix, the cellulose content is outside the dissolving range defined by U.S. Pat. No. 4,196,282. A portion of the cellulose is provided in its undissolved state.

Salt was added to that premix in a ratio of 5.9:1. The obtained mixture was processed to a sponge as in Example 1.

In the state of never having been dried, the obtained sponge possessed the following properties:

| | |
|---|---|
| density | 38.4 g/l |
| strength | 0.54 daN/cm² |
| water retention capacity (WRC) | 29.2 times the dead weight |

### Examples 3-8 (according to the invention)

Premixes of NMMO, water and pulp (Viscokraft 1060, manufacturer: International Paper) each were produced in a Z-arm mixer comprising an extruder discharge screw, without any water being evaporated. Salt having an average grain size of from 1 mm to 1.5 mm was added to those premixes. In Examples 3 to 7, the obtained mixtures were processed to sponges by extruding them into a mould, and, in Example 8, by pressing them by hand into a rectangular mould, whereby the more precise conditions of the respective methods as well as the properties of the never dried sponges which were obtained are shown in the following table:

| | Example | | | | | |
|---|---|---|---|---|---|---|
| | 3 | 4 | 5 | 6 | 7 | 8 |
| Content of cellulose in | 10.9% by weight | | | | | |
| the premix | | | | | | |
| Content of NMMO in | 69.1% by weight | | | | | |
| the premix | | | | | | |
| Content of water in the | 20.0% by weight | | | | | |
| premix | | | | | | |
| Ratio of added salt: | 6:1 | | | | | |
| premix | | | | | | |
| Temperature of the | 100° C. | | | | | |
| mixture prior to | | | | | | |
| forming | | | | | | |
| Conditions of forming | 20 bar* | 30 bar | 35 bar | 20 bar | 30 bar | pressed |
| | | | | | | by hand |
| Coagulation/ | 1** | 1 | 1 | 2 | 2 | 1 |
| washing out | | | | | | |
| Density (g/l) | 40.1 | 42.5 | 49.2 | 44 | 43.5 | 39 |
| Strength (daN/cm²) | 0.23 | 0.47 | 0.63 | 0.73 | 0.61 | 0.27 |
| WRC | 24.6 | 22.4 | 20.1 | 22.5 | 22.6 | 23.5 |

*The mixture was pressed at 100° C. with the pressure indicated in each case or by hand in Example 8, respectively, in a rectangular mould for the production of block sponges.
**“1” means: cooling down to room temperature, 24 hours of coagulation/washing out with water at 50° C.;
“2” means: cooling down to −10° C., 24 hours of coagulation/washing out with water at 50° C.

### Example 9 (according to the invention)

In a Werner-Pfleiderer kneader, 42.3 g of pulp (type Solucell, manufacturer Messrs. Bacell, moisture 5.4%) is mixed with 778.97 g of 78% NMMO and 90.83 g of NMMO monohydrate and is kneaded for a few minutes at 80° C. Within 5 minutes, 87.9 g of flax fibres (moisture 9%) are added to that premix. Kneading is continued for another 5 minutes at 90° C.

Subsequently, 2580 g of NaCl having a grain size of from 0.5 to 1 mm is added. Prior to that, the salt was preheated to 80-90° C. Kneading of the resulting mixture is continued for another 10 minutes at from 90° C. to 100° C.

Afterwards, 640 g of preheated NaCl having a grain size of less than 25 μm is added. The mixture is kneaded for another 10 minutes at 90-100° C. Eventually, 1250 g of NaCl having a grain size of >4 mm is added. Kneading is continued for another 5 minutes at from 90° C. to 100° C.

The mixture thus obtained is placed into a mould for the production of block sponges and is coagulated in water or is washed free from NMMO and salt, respectively.

In the state of never having been dried, the resulting block sponge exhibits the following properties:

| | |
|---|---|
| density | 37.2 g/l |
| strength | 1.00 daN/cm² |
| water retention capacity (WRC) | 20.8 times the dead weight |

### Example 10 (according to the invention)

The same procedure as in Example 9 was followed but with the following amounts being used:

63.4 g of pulp of Solucell type

131.9 g of flax fibres

1175.1 g of 78% NMMO

129.7 g of NMMO monohydrate

1548 g of salt having a grain size of from 0.5 to 1 mm

1152 g of salt having a grain size of less than 25 μm

1250 g of salt having a grain size of >4 mm

In the state of never having been dried, the resulting block sponge exhibits the following properties:

| | |
|---|---|
| density | 61.9 g/l |
| strength | 1.25 daN/cm² |
| water retention capacity (WRC) | 14.2 times the dead weight |

From Examples 9 and 10 it is evident how a person skilled in the art will be able to control the properties of the resulting sponge over a wide range, among other things, by choosing the type and amount of the feed materials.

### Examples 11 and 12 (according to the invention)

In those Examples, sponges produced according to the invention are compared, with flax being used as the reinforcement fibres in one case and polyester being used as the reinforcement fibre in the other case.

In both Examples, at first a premix having the following components was prepared in a mixing aggregate:

| | Example No. | |
|---|---|---|
| | 11 | 12 |
| NMMO 77.8% | 5.94 kg | 5.94 kg |
| Pulp “Extranier F” | 0.462 kg | 0.462 kg |
| Flax fibres of type “STW” | 0.198 kg | — |
| Polyester fibre of type “Dracon” Fiberfill | — | 0.198 kg |
| 13 dtex, 50 mm | | |

The NMMO is provided and then preheated to 78° C. Subsequently, the coarsely shredded pulp is added in sheet form and is mixed at the same temperature. After adding the amount of flax fibres or polyester fibres, respectively, mixing is continued for another 7 minutes at 72° C. and heating to 78° C. is effected. After reaching that temperature, mixing is continued for another 5 minutes.

The apparatus is emptied, and, in Example 11, 0.623 kg and, in Example 12, 0.723 kg of the obtained premix and in each case 6 kg of NaCl having a grain-size fraction of from 0.5 to 1 mm and a grain-size fraction of >3 mm are filled into the emptied apparatus. The ratio between the grain-size fraction of from 0.5 to 1 mm and the grain-size fraction of >3 mm amounted to 7:3. At first, the salt is provided and, subsequently, the calculated amount of premix is added. Prior to that addition, the salt was preheated to 80° C.

Kneading is continued for another 15 minutes at 85° C., the mass is taken out and is put by hand into a rectangular mould. After cooling down to room temperature, the mass is coagulated or washed, respectively, with water for 12 hours at 50° C.

The properties of the sponges in the state of never having been dried which were obtained are summarized in the following table:

| | Example No. | |
|---|---|---|
| | 11 | 12 |
| Amounts of pulp | 7% of pulp (Extranier F) | 7% of pulp (Extranier F) |
| or reinforcement | 3% of flax fibres | 3% of polyester fibres |
| fibres, respectively | | |
| Density (g/l) | 42.3 | 28.3 |
| Strength (daN/cm²) | 0.42 | 0.30 |
| WRC | 22.6 times the | 30.8 times the |
| | dead weight | dead weight |

### Example 13 (according to the invention)

A mixture of the following components was prepared:

42.3 g of pulp (manufacturer: Bacell, type Solucell)

75.8 g of flax fibres of type “STW”

10.8 g of glass fibres which were taken from an insulating material (meltblown fabric)

79.5 g of NMMO monohydrate

791.7 g of 77.8% NMMO

1.0 g of gallic acid propyl ester (GPE) as a stabilizer

8.71 g of 50% NaOH

2580 g of NaCl having a grain size of from 0.5 to 1 mm

640 g of NaCl having a grain size of less than 25 μm

1250 g of NaCl having a grain size of >4 mm

At first, NMMO monohydrate, 78% NMMO and a stabilizer (GPE) were provided in a kneader of the Werner-Pfleiderer type and were stirred at 60° C. Then, the pulp, the flax fibres and the glass fibres were added. The mixture was stirred for about 10 minutes at about 100° C.

Subsequently, salt was added successively: at first the salt having a grain size of from 0.5 to 1 mm, then the salt having a grain size of less than 25 μm and finally the salt having a grain size of >4 mm. In between, stirring was effected in each case for about 5 minutes at about 95° C. The salt fractions were preheated to about 55-60° C. in each case.

The resulting mixture was placed into a mould for the production of block sponges and was coagulated or washed out, respectively, with water for 48 hours at about 90° C.

In the state of never having been dried, the obtained block sponge possessed the following properties:

| | |
|---|---|
| density | 40 g/l |
| strength | 0.51 daN/cm² |
| water retention capacity (WRC) | 21.3 times the dead weight |

In addition, the sponge exhibits abrasive properties.

### Examples 14 to 16 (according to the invention)

In each case, 50% NMMO was provided in a kneader, and cotton fibres were added. The mixture was impregnated at 250 mbar for 30 minutes. Subsequently, water was distilled off by decreasing the pressure and heating the kneader.

In doing so, such amounts of water were distilled off in each case that—starting out from the provided amounts of 50% NMMO and cotton—premixes were created in which

the total content of cotton amounted to 12% by weight and

(in theory) only a certain amount of cotton could be dissolved according to the limits of dissolution indicated in U.S. Pat. No. 4,196,282, namely (in each case based on the entire premix)

2% of dissolved cotton

4% of dissolved cotton and

6% of dissolved cotton.

In each case, 200 g of NaCl preheated to 100° C. and having a grain size of about 1 mm was added to 100 g of the obtained premixes, in which an amount of cotton of a different size in each case had been dissolved or still was undissolved, respectively. The mixture continued to be kneaded in the kneader for 10 minutes at atmospheric pressure.

Subsequently, the obtained mixtures were formed to globules which were put in water. Subsequently, boiling out in water was effected for 6 hours in order to remove NMMO and the salt. In between, the wash water was changed.

In those Examples, the moisture content in % of the obtained test specimens was determined as follows:

After having been boiled out in water, the globules were weighed without squeezing them (leads to initial weight EW1). Subsequently, the samples were dried at 110° C. in the circulating air drier for 2.5 hours and were weighed again (leads to final weight AW1).

Subsequently, the samples were watered and squeezed by hand under water until no more air bubbles ascended, were shaken once and weighed again (leads to initial weight EW2).

The moisture content in % for the never dried samples is derived from the formula (EW1 −AW1)/EW1×100.

The moisture content in % for the once dried samples is derived from the formula (EW2 −AW1)/EW2×100.

According to the content of (theoretically) dissolved cotton in the premix from which the samples were produced, the following values resulted:

| | Example No. | | |
|---|---|---|---|
| | 14 | 15 | 16 |
| Content of (theoretically) | 2% | 4% | 6% |
| dissolved cotton in the premix | by weight | by weight | by weight |
| Moisture content, never dried | 87.5% | 84% | 77.2% |
| Moisture content, once dried | 79.4% | 80.3% | 54.7% |

It is clearly evident that, with a smaller content of (theoretically) dissolved cotton in the premix, higher absorption capacities (larger moisture contents) result.

We claim:

1. A process for producing a cellulose sponge by using tertiary amine oxides, wherein a mixture of cellulose and further ingredients such as pore formers (gas, salt or blowing agents) is produced in an aqueous tertiary amine oxide, which mixture contains undissolved and/or highly swollen cellulose, and the mixture is formed and coagulated.

2. A process according to claim 1, characterized in that the aqueous tertiary amine oxide is N-methyl morpholine-N-oxide and the expression
A>34,69−1,695*B+0,81*\sqrt{1,65+0,1*(B−12,76)²}
is fulfilled in the mixture, wherein
A is the content of cellulosic material in the mixture (% by weight), based on the sum of the percentages by weight of cellulosic material, water and amine oxide in the mixture, and
B is the water content in the mixture (% by weight), based on the sum of the percentages by weight of cellulosic material, water and amine oxide in the mixture.

3. A process according to claims 1, characterized in that a premix consisting of cellulose, aqueous amine oxide and optionally a stabilizer is prepared.

4. A process according to claim 3, characterized in that the aqueous tertiary amine oxide is N-methyl morpholine-N-oxide and the expression
A1>34,69−1,695*B1+0,81*\sqrt{1,65+0,1*(B1−12,76)²}
is fulfilled in the premix, wherein
A1 is the cellulose content in the premix (% by weight), based on the sum of the percentages by weight of cellulose, water and amine oxide in the premix, and
B1 is the water content in the premix (% by weight), based on the sum of the percentages by weight of cellulose, water and amine oxide in the premix.

5. A process according to claim 3, or characterized in that the concentration of dissolved cellulose in the premix is smaller than 7% by weight of cellulose, preferably ranges from 2 to 6% by weight of cellulose, particularly preferably from 3 to 4% by weight of cellulose, based on the sum of the percentages by weight of cellulose, water and amine oxide.

6. A process according to claim 1, characterized in that the mixture contains undissolved reinforcement fibres.

7. A process according to claim 6, characterized in that the reinforcement fibres are added to the premix.

8. A process according to claim 6, characterized in that the reinforcement fibres are synthetic fibres, cellulose and/or inorganic fibres.

9. A process according to claim 8, characterized in that the reinforcement fibres are cellulose fibres and the total content of cellulosic material in the mixture is less than 12% by weight, based on the sum of the contents of cellulosic material, amine oxide and water in the mixture.

10. A process according to claim 8, characterized in that the reinforcement fibres are cotton fibres, flax fibres and/or cross-linked manmade cellulose fibres.

11. A process according to claim 8, characterized in that the reinforcement fibres are polyester, polyamide, polypropylene, polyethylene and/or polyacrylic fibres.

12. A process according to claim 6, characterized in that at least a portion of the reinforcement fibres is chemically functionalized.

13. A process according to claim 3, characterized in that the further ingredients such as pore formers (gas, salt or blowing agents) are added to the premix.

14. A process according to claim 1, characterized in that the mixture contains a salt, preferably sodium chloride, sodium sulfate, potassium chloride and/or potassium sulfate.

15. A process according to claim 14, characterized in that, in the mixture, the ratio between the weight percentage of salt and the sum of the weight percentages of cellulosic material, amine oxide and water amounts to from 2:1 to 8:1, preferably from 3:1 to 7:1, particularly preferably from 4:1 to 7:1.

16. A process according to claim 14, characterized in that the salt has different grain-size fractions.

17. A process according to claim 16, characterized in that the salt has at least partially a grain size of from 0.1 to 2 mm.

18. A process according to claim 16, characterized in that the salt has at least partially a grain size of more than 3 mm.

19. A process according to claim 1, characterized in that an aqueous amine oxide is used, the water content of which amounts to from 15% by weight to 30% by weight, preferably from 17% by weight to 26% by weight, particularly preferably from 19% by weight to 24% by weight, most preferably 22% by weight.

20. A process according to claim 1, characterized in that the mixture contains further ingredients which impart functional properties to the formed sponge.

21. A process according to claim 1, characterized in that processing is carried out in a single apparatus, which means that the pore formers such as gas-propellent organic or inorganic substances, respectively, salts or gases as well as reinforcement materials—cellulosic as well as non cellulosic materials—are mixed in one and the same apparatus and simultaneously part of the cellulosic materials is solubilized by the present amine oxide.

22. A process according to claim 21, wherein the apparatus used to that end is a combination of a mixer and a kneader and optionally an extruder.

23. A process according to claim 1, characterized in that no water is evaporated in that process.

24. A cellulose sponge, obtainable in accordance with a process according to claim 1.

25. A cellulose sponge according to claim 24 in the shape of a block sponge.

26. A cellulose sponge according to claim 25, characterized by a density of from 20 to 60 kg/m³, preferably from 25 to 45 kg/m³, an absorption capacity of from the 10 to the 40-fold, preferably from the 15 to the 30-fold, of the dead weight and a strength of from 0.5 to 5 daN/cm².

27. A cellulose sponge according to claim 24 in the shape of a sponge cloth.
